(19) United States
(12) Patent Application Publication
(10) Pub. No.: US 2005/0273345 A1
(43) Pub. Date: Dec. 8, 2005

(54) In-restaurant automated meal ordering by customers

(75) Inventor: Alejandro Castillejo Romero, Malaga (ES)

Correspondence Address: MICHAEL J. BUCHENHORNER, ESQ;HOLLAND & KNIGHT, 701 BRICKELL AVENUE, MIAMI, FL, 33131, US

(73) Assignee: Click & Eat, Restaurante Interactivo, S.L.

(21) Appl. No.: 10/858,756

(22) Filed: Jun. 2, 2004

(51) Int. Cl. G06F 17/60

(52) U.S. Cl. 705/1; 705/15

(57) ABSTRACT

A method, information processing system and computer readable medium for placing a meal order on an information processing system located within a food establishment is disclosed. The method includes providing to a customer a plurality of selectable meal order items on an interface and receiving from the interface a selection of at least one meal order item selected by the customer. The method further includes placing an order for the at least one meal order item selected by the customer.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of food establishment automation and more particularly relates to the field of automation of meal orders by diners inside food establishments.

### BACKGROUND OF THE INVENTION

Over the last decades, Americans have increased their awareness of personal health. More and more, people are exercising, watching their diets and generally living more healthy lives. This is reflected in the food individuals eat, the amount of exercise that is performed and the type of leisure activities in which people engage. As individuals seek to lead healthier lives, they look to establish healthy eating habits. Often, this involves a moderate amount of time and energy that is expended researching the proper foods and diets and seeking stores, restaurants and food establishments where they can fulfill their healthy eating habits. This can be time consuming and tedious.

At the same time, the use of technology to simplify tasks and automate processes is increasing. Since the technology boom of the 1990s, the level of use of technology in all facets of life has increased. On a daily basis, many people use cell phones, computers, the Internet. ATMs and other computing devices. Thus, the level of computer-literate and tech-savvy individuals has increased. However, there has been little progress in the use of technology to aid individuals in their quest for healthy eating. Moreover, the use of technology in restaurants has not progressed much in the last decade.

Therefore, a need exists to overcome the problems with the prior art as discussed above, and particularly for a way to simplify the task of ordering meals by diners while at a food establishment.

### SUMMARY OF THE INVENTION

Briefly, according to an embodiment of the present invention, a method for placing a meal order on an information processing system located within a food establishment is disclosed. The method includes providing to a customer a plurality of selectable meal order items on an interface and receiving from the interface a selection of at least one meal order item selected by the customer. The method further includes placing an order for the at least one meal order item selected by the customer.

Also disclosed is an information processing system located within a food establishment for placing a meal order. The information processing system includes a display for providing to a customer a plurality of selectable meal order items and an interface for receiving a selection of at least one meal order item selected by the customer. The information processing system further includes a processor configured to place an order for the at least one meal order item selected by the customer.

The method can also be implemented as machine executable instructions executed by a programmable information processing system or as hard coded logic in a specialized computing apparatus such as an application-specific integrated circuit (ASIC). Thus, also disclosed is a computer readable medium including computer instructions for placing a meal order on an information processing system located within a food establishment. The computer readable medium includes instructions for providing to a customer a plurality of selectable meal order items on an interface and receiving from the interface a selection of at least one meal order item selected by the customer. The computer readable medium further includes instructions for placing an order for the at least one meal order item selected by the customer.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of an interactive terminal located on a table in a food establishment, in one embodiment of the present invention.

FIG. 2 is a high level block diagram showing the system architecture of one embodiment of the present invention.

FIG. 3 is a more detailed block diagram showing the system architecture of one embodiment of the present invention.

FIG. 4 is an illustration of a graphical user interface for placing a meal order, according to one embodiment of the present invention.

FIG. 5 is a screenshot of the graphical user interface of FIG. 4, according to one embodiment of the present invention.

FIG. 6 is a flowchart showing the control flow of the meal order process of one embodiment of the present invention.

FIG. 7 is a high level block diagram showing an information processing system useful for implementing one embodiment of the present invention.

### DETAILED DESCRIPTION

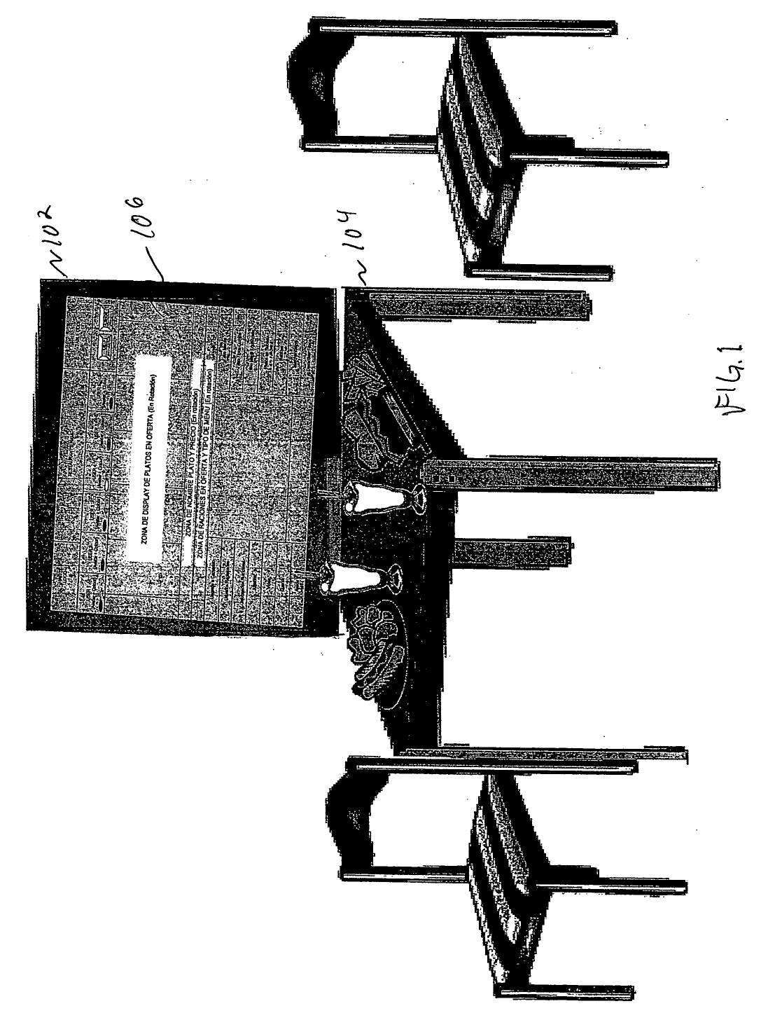

FIG. 1 is an illustration of an interactive terminal 102 located on a table 104 located within in a food establishment, in one embodiment of the present invention. A food establishment includes a restaurant, a fast food restaurant, a diner, a café, a sandwich shop, a bakery or any other establishment for providing food and/or meals to customers. FIG. 1 shows that a terminal 102 is located on the table 104 such that information may be provided to the customers of the food establishment and the customers may place meal orders. Customers of the food establishment may also be referred to as diners, consumers, users, end-users or clients. FIG. 1 shows that the terminal 102 consists solely of a flat panel display for providing visual information to the customer. In this embodiment, the flat panel display is also a touch screen such that the terminal 102 allows the input of information via the touch screen. The user touches the screen of the flat panel display to input selections, navigate through data and arrange meal order items. The flat panel display may also include speakers for providing audio information to the customer.

In another embodiment of the present invention, the terminal 102 includes other means of allowing the customer to input information. In this embodiment, the terminal 102 includes peripherals allowing the input of data, such as a keyboard, a mouse, a roller ball, a touch pad, a microphone and a game controller. In yet another embodiment of the present invention, the terminal 102 includes other means of providing information to the customer. In this embodiment, the terminal 102 includes peripherals allowing the output of data, such as additional speakers, additional displays, LED or LCD displays and tactile devices.

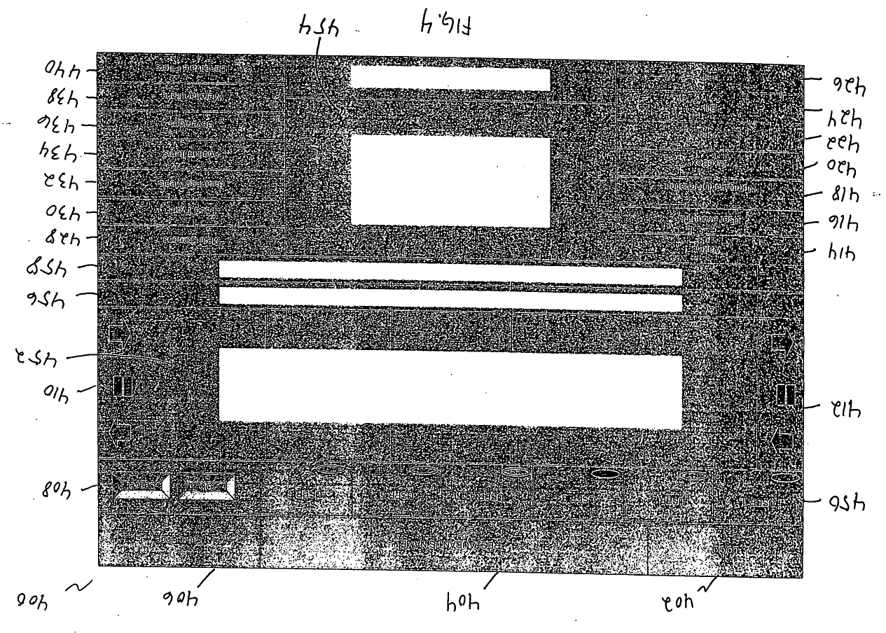

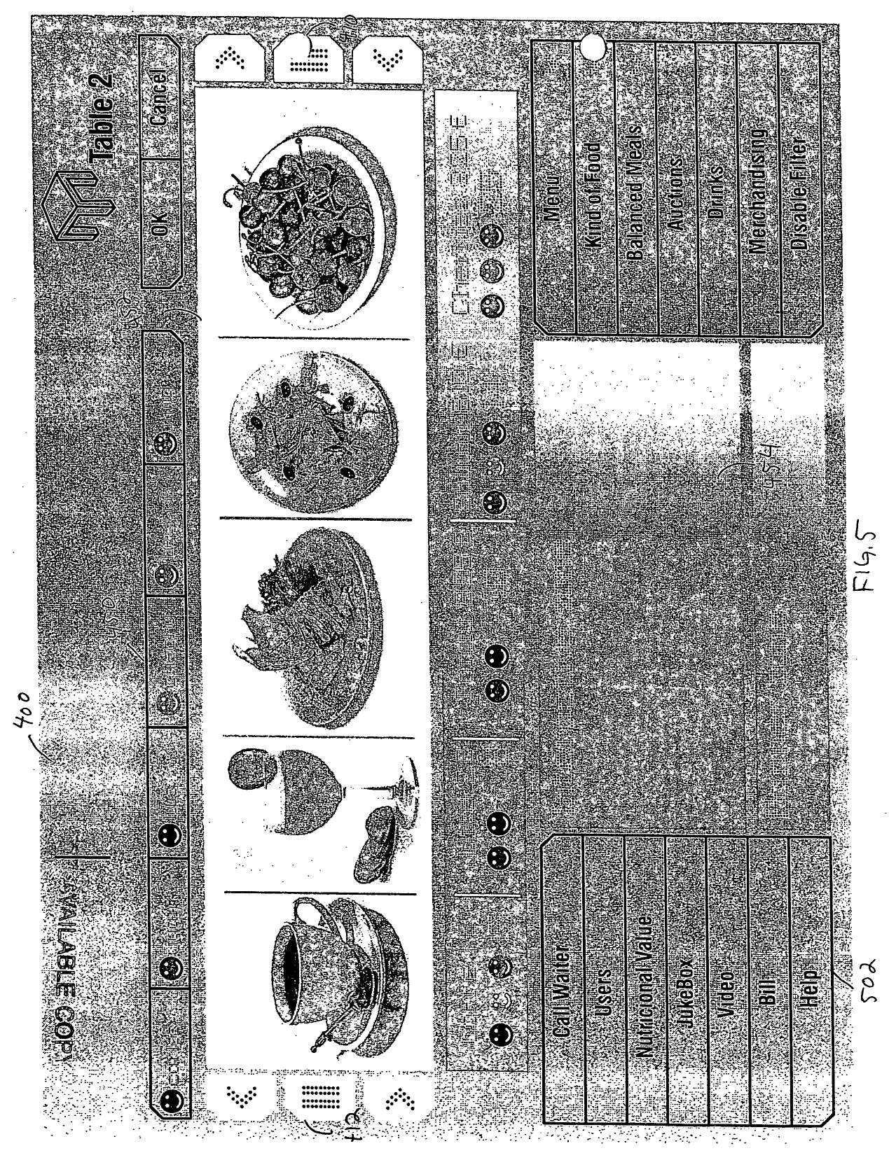

FIG. 1 further shows that a graphical user interface 106 is presented in the display of the terminal 102. The graphical user interface 106 provides an interface to the customer for providing relevant information and allowing the customer to provide input information to the system of the present invention. The graphical user interface 106 can be a software application working in conjunction with a touch screen and other peripheral devices for allowing the input and output of information. The graphical user interface 106 is described in greater detail with reference to FIG. 4 and FIG. 5 below.

In another embodiment of the present invention, the terminal 102 can be located at a special station for take out orders. Thus, the terminal 102 can be placed at a kiosk or a special table wherein customers can walk in to the food establishment and place meal orders for take out via the terminal 102, in the same manner as eat-in customers.

The embodiments of the present invention are advantageous as they provide a simple and easy-to-use terminal on each table of a food establishment for allowing a user to place a meal order. The system of the present invention is further advantageous as it allows a user to select music and video for viewing, as well as order merchandise and other items for purchase. Further, the present invention is beneficial as it allows for users to buy meal order items at auction and/or at time-based prices, thus allowing for the fair market value of meal order items to be realized. The system of the present invention further allows a centralized computer system to control production, daily menus, etc. at each restaurant, thereby allowing centralized control of a plurality of food establishments.

The embodiments of the present invention are further advantageous as they provide customers access to personalized attention for their food tastes and dietary preferences. Users are provided with nutritional information regarding meal order items as well as information on dietary plans and dietary preferences. The system of the present invention further allows users to order freshly-cooked meals quickly using a computer. The present invention is further beneficial as it allows for a decrease in the number of waiters or food servers necessary to operate a food establishment, as a computer system is used to take meals orders.

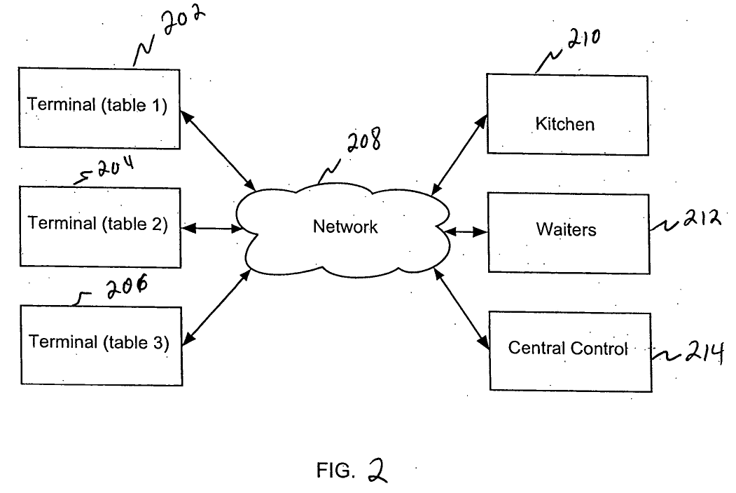

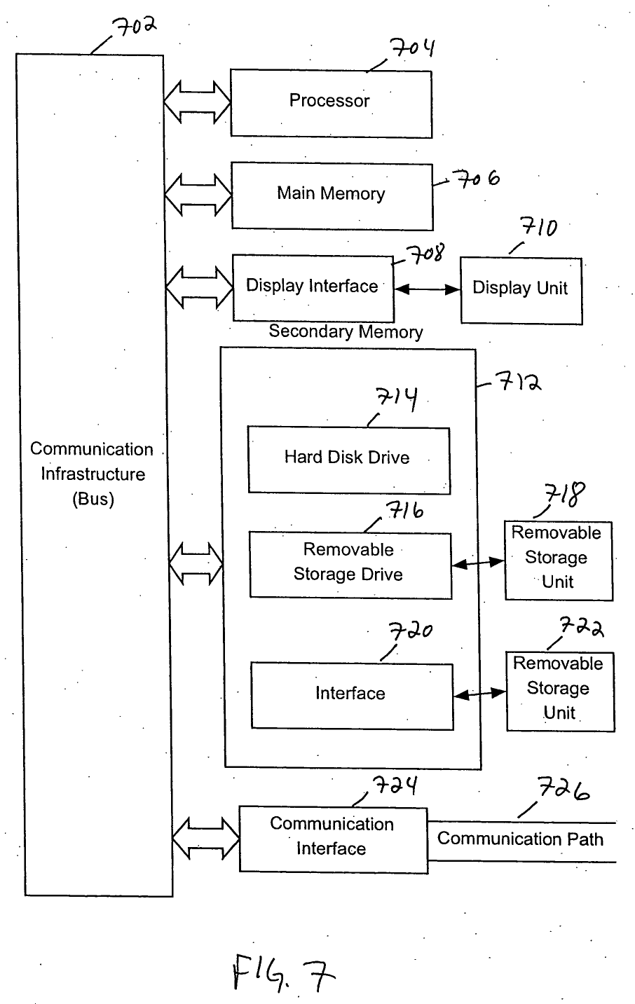

FIG. 2 is a high level block diagram showing the system architecture of one embodiment of the present invention. FIG. 2 shows a network for automating the generation of meal orders and the provision of meal information within a food establishment. FIG. 2 shows terminals 202, 204 and 206, each terminal being located on a table or other seating arrangement within a food establishment. A terminal includes a flat panel display, a CRT or other display apparatus for providing information to the customer. A terminal may also include components of an information processing system or a computer, which is described in greater detail with reference to FIG. 7 below. As explained above, a terminal may also include additional peripherals for allowing the input and output of information from the terminal.

FIG. 2 further includes a network 208 to which the terminals 202, 204 and 206 are connected. The network 208 allows for the exchange of information garnered during the input and output of information that occurs at the terminals 202, 204 and 206. In an embodiment of the present invention, the network 208 is a circuit switched network, such as the Public Service Telephone Network (PSTN). In another embodiment, the network 208 is a packet switched network. The packet switched network is a wide area network (WAN), such as the global Internet, a private WAN, a telecommunications network or any combination of the above-mentioned networks. In yet another embodiment, the network 208 is a wired network, a wireless network, a broadcast network or a point-to-point network.

FIG. 2 further includes an information processing system, or computer, located in the kitchen 210, or other food preparation area, of the food establishment of the present invention. This unit 210 allows for the provision of information to individuals or information processing systems, or computers, within the kitchen of the food establishment. Unit 210 allows workers, or computers, in the kitchen of the food establishment to receive information such as meal orders generated by consumers at the terminals 202, 204 and 206, and meal orders generated by waiters or other entities.

FIG. 2 further includes an information processing system, or computer, located in an area for waiters 212, or other food servers, that are employed by the food establishment of the present invention. This unit 212 allows for the provision of information to individuals or information processing systems, or computers, located in the food server area of the food establishment. Unit 212 allows workers, or computers, in the food server area of the food establishment to receive information such as meal orders generated by consumers at the terminals 202, 204 and 206, and information sent by workers located in the kitchen area.

FIG. 2 further includes an information processing system, or computer, acting as a central control mechanism 214 for the food establishment of the present invention. This unit 214 can receive all information generated, transmitted and received by all other entities of the food establishment, such as terminals 202, 204 and 206, the kitchen unit 210 and the waiters unit 212. Unit 214 can manage all aspects of the functions of the food establishment, such as the pricing of meals and meal order items, the conveyance of information to the kitchen unit 210, inventory maintenance of all items in the food establishment, bookkeeping, accounting, and related aspects. The functions of terminals 202, 204, and 206, kitchen unit 210, waiters unit 212 and central control unit 214 are described in greater detail below.

In an embodiment of the present invention, the computer systems of terminals 202, 204, and 206, kitchen unit 210, waiters unit 212 and central control unit 214 are one or more Personal Computers (PCs) (e.g., IBM or compatible PC workstations running the Microsoft Windows operating system, Macintosh computers running the Mac OS operating system, any PC running the LINUX operating system, or equivalent), Personal Digital Assistants (PDAs), hand held computers, palm top computers, smart phones, game consoles or any other information processing devices. In another embodiment, the computer systems of terminals 202, 204, and 206, kitchen unit 210, waiters unit 212 and central control unit 214 are a server system (e.g., SUN Ultra workstations running the SunOS operating system or IBM RS/6000 workstations and servers running the AIX operating system). The computer systems of terminals 202, 204, and 206, kitchen unit 210, waiters unit 212 and central control unit 214 are described in greater detail below with reference to FIG. 7.

It should be noted that although kitchen unit 210, waiters unit 212 and central control unit 214 are shown as separate entities in FIG. 2, the functions of these entities may be integrated into one combined entity. It should also be noted that although FIG. 2 shows only three terminals, the present invention supports any number of terminals located on tables of the food establishment.

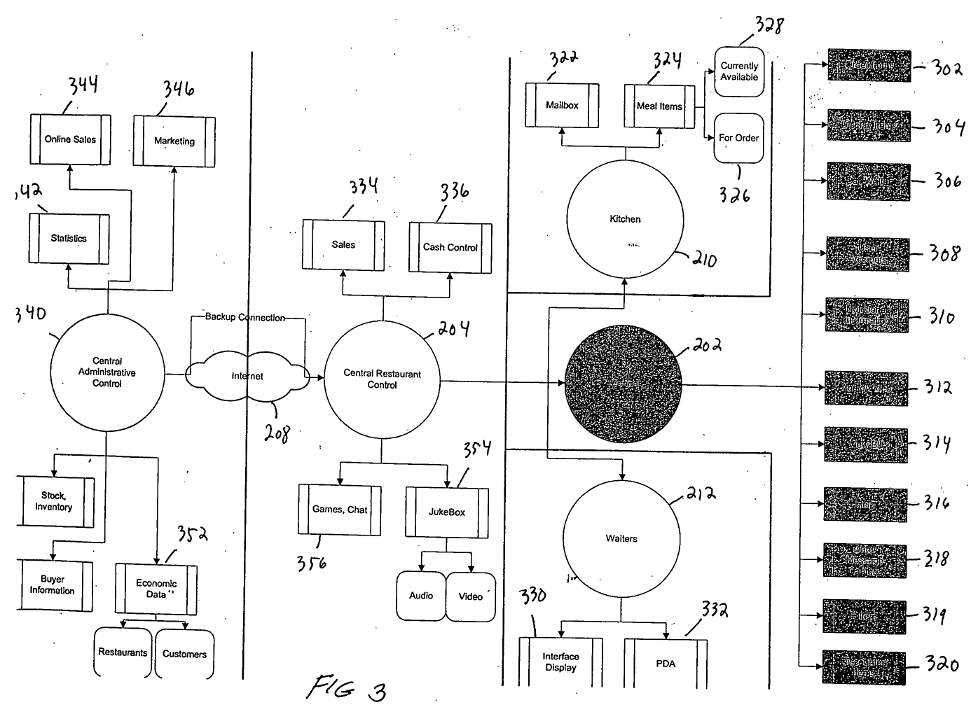

FIG. 3 is a more detailed block diagram showing the system architecture of one embodiment of the present invention. FIG. 3 shows more detail of the system architecture depicted in FIG. 2. The system of FIG. 3 shows a multi-disciplinary computer system for managing various aspects of the food establishment business, from the placement of a meal order to the regulation of inventories and stock.

FIG. 3 includes a table unit, or terminal, 202 that provides an interface to a customer at a table. The interface includes a routine 302 for allowing the ordering of meal order items, a routine 304 for allowing the display of photos or other images representing meal order items, a routine 306 for requesting the assistance of a food server or waiter, a routine 308 for managing user accounts, registering customers, customer passwords and customer unique identifiers, a routine 310 for displaying nutritional information of meal order items, a routine 312 for operating a jukebox or other audio/video output mechanism, a routine 314 for allowing the user(s) to view the bill or receipt or make changes to the receipt, a routine 316 for providing help to a user requiring assistance in using the, a routine 318 for capturing and displaying data and messages, a routine 319 for executing filters and other data arrangement indicators and a routine 320 for displaying information on meal order items that are discounted or whose price is variable depending on time of food preparation, etc.

FIG. 3 further includes a kitchen unit 210 that provides an interface to kitchen workers or computers. The interface includes a routine 322 for functioning as a software or hardware implementation of a pigeonhole or meal order system used to manage the transmission, reception and storage of meal orders sent to the kitchen. Also included in kitchen unit 210 is a database 324 of meal order items. A meal order item is a single meal item including an appetizer, an entree, a side dish, a desert, a beverage or any other single food item. One or more meal order items comprise a full meal order. A meal order item may be categorized as a regular meal order item 326 that currently being cooked, or it may be categorized as an available meal order item 328 that is currently immediately available at the kitchen for immediate delivery to a table and consumption.

FIG. 3 further includes a waiter unit 212 for providing an interface to a food server area of the food establishment. The interface includes a display 330 for providing necessary information. The waiter unit 212 further allow for an interface with a mobile device 332. A mobile device 332 is used by a waiter or other food server to gather, input and receive meal order information. The mobile device 332 can be a handheld computer, a palmtop computer, a PDA, a smart phone or any other small computing device.

FIG. 3 further includes a central restaurant control unit 204. The central restaurant control unit 204 includes a database 334 for storing sales and other accounting information. The central restaurant control unit 204 further includes a cash control system 336 for controlling cash and coin items, such as a cash register system or a safe. The central restaurant control unit 204 further includes a routine 354 for operating a jukebox or other audio/video output mechanism and a routine 356 for interacting with the customer such as using games or live chat. Routine 356 can provide a series of chat rooms pertaining to different subjects and interests. Customers can navigate through the different chat rooms engage in chat sessions with other participating customers.

It should be noted that preferably, the system of the central restaurant control unit 204, the kitchen unit 210 and the waiters unit 212 are located within a food establishment while the terminals 202-206 are located at tables within a food establishment. As shown in FIG. 2, the central restaurant control unit 204, the kitchen unit 210 and the waiters unit 212 are connected to a network 208.

FIG. 3 further includes a central administrative control unit 340 that is connected to the network 208 or, alternatively, directly to central restaurant control unit 204. The central administrative control unit 340 controls or regulates all aspects of each individual food establishment via the respective central restaurant control unit 204. The central administrative control unit 340 is meant to control or regulate a plurality of food establishments and includes a database 342 for storing all statistics related to the business of the food establishments, including number of meal order items sold, revenue, costs, etc. The central administrative control unit 340 includes an online system 344 for allowing the sale of meal order items and merchandise online over the global Internet. Customers can order meals online and then have the meals delivered to them, or available for pick up via take out. The central administrative control unit 340 further includes an online system 346 for allowing marketing and other materials to be transmitted to prospective clients and to the public at large via email or the World Wide Web.

The central administrative control unit 340 further includes a database 348 for storing meal order item information including current inventory, stock and related information. The central administrative control unit 340 further includes a database 350 for storing sales, proposal and related information and a database 352 for storing economic data relating to individual food establishments and customers.

Each central restaurant control unit 204 can be permanently connected through a Virtual Private Network to the central administrative control unit 340, such that various types of information on the individual restaurant is available at any time, such as warehousing, billing, purchasing, statistics on consumption, registered customers, statistics on the use of the premises, number of customers currently in the restaurant, etc.

Additionally, the central administrative control unit 340 may assist the individual restaurants in different ways. For example, the central administrative control unit 340 may suggest the meals that should be prepared each day (depending upon the day of the week, weather, season, as a function of statistics received by 340, etc.). The central administrative control unit 340 may give each restaurant information on the amount and type of business performed every day. The central administrative control unit 340 may also control user membership and act as a business tool.

Moreover, the central administrative control unit 340 may manage production requests online and provide comparative statistics on the business and production performed at the various restaurants in the chain. The central administrative control unit 340 may also examine in detail each of the dishes that are created and any purchasing shortages or overages. Additionally, the central administrative control unit 340 may analyze the productivity of the servers and staff in the room. The central administrative control unit 340 may analyze the response time for requests for each of the dishes based upon the number of people in the restaurant, the weather that day, etc., which enables the head chef to suggest what should be purchased over the next few days.

FIG. 4 is an illustration of a graphical user interface 400 for placing a meal order, according to one embodiment of the present invention. FIG. 4 is a software implementation of a user interface for providing information to a customer and receiving information from the same. In an embodiment, the interface 400 is displayed on a touch screen flat panel display for allowing a customer to input information using his hands or a stylus. In another embodiment, the interface 400 is displayed on a typical flat panel display or CRT having a mouse, keyboard or other input device for allowing a customer to input information.

The interface 400 includes a logo section 402 for including a logo, name or slogan of the food establishment or other entity, a name section 404 for including the name of the food establishment and a table code section 406 where a unique identifier of the respective table is displayed. The interface 400 further includes a horizontal section 452 that includes a series of rectangular areas or tiles on which images of meal order items are displayed. The horizontal section 452 is a sliding, rotating or scrolling bar or wheel that can be moved by using the controls 412 or 410 on either side of the horizontal section 452. As rectangular areas or tiles are scrolled out to the right, new tiles appear to the left and, conversely, as rectangular areas or tiles are scrolled out to the left, new tiles appear to the right. The controls 412 or 410 include buttons for scrolling in either the right or left direction, as well as a button for stopping or pausing the rotation or scrolling of the horizontal section 452.

Located under each tile of the horizontal section 452 is another tile for displaying name, price and other information for each meal order item. The horizontal section 456 includes a set of smaller tiles that are attached to and rotate with a corresponding tile in horizontal section 452. The tiles of horizontal section 456 display additional information about a meal order item, including the name of the meal order item, the price of the item, the nutritional information associated with the item, etc.

Located under each tile of the horizontal section 456 is yet another tile for displaying additional information for each meal order item displayed in the horizontal section 452. The horizontal section 458 includes a set of smaller tiles that are attached to and rotate with a corresponding tile in horizontal section 456. The tiles of horizontal section 458 display additional information about a meal order item, including the number of servings of each meal order item and at least one color associated with a customer so as to indicate that the meal order item is associated with a customer's dietary profile.

The tiles of horizontal section 458 may also display the current number of meal order items of that type that are immediately available for delivery and consumption. That is, as the meal order items of that type are prepared at the kitchen and ready for consumption, the quantity of that item that is available is displayed in horizontal section 458. This provides a user with an indication as to which meal order items are available immediately for delivery and consumption. A waiter or food server can respond to a user's selection immediately, thus allowing a user to have a selected meal order item quickly. This serves to reduce wait time for consumers and allows a quicker and more user-friendly experience for the consumer.

As explained above, each rectangular area or tile of the horizontal section 452 represents a meal order item. When the customer decides that he would like more information on a meal order item, he can click on the appropriate tile. This results in additional information being displayed in area 454, such as an image of the meal order item, price information, nutritional information, diet information, or the like. Section 408 shows “OK” and “Cancel” buttons for use during the course of interacting with the graphical user interface 400.

FIG. 4 further shows a button 414 for calling a waiter or food server. Also shown is a button 416 for registering and managing user identifications. Using button 416, a user can initiate another graphical user interface that can be used to create a user account including a unique user identifier, a unique color and a file for storing a user's dietary profile, a user's dietary preferences and a history of a user's ordered meals. The graphical user interface can also be used to manage user accounts. A user's account or file can be used to store points that are earned as the user consumes meals at the food establishment. A user's account or file can also be used to set display preferences such as brightness. The system of the present invention can provide special offers, discounts and promotions to customers whose accounts reflect a repeat or frequent customer.

A customer can log onto his account from the terminal 202 or the from anywhere on the Internet to view his account information. A user's account can store a variety of information, such as food preferences, the customer's eating schedule, the restaurants visited by the customer and the meals ordered by the customer. A user's account may also reflect whether the user prefers to receive messages (email, SMS, MMS or any text messages) from the system of the present invention, indicating discounts, offers or promotions.

FIG. 4 further shows a button 418 for providing nutritional information about a meal order item. In one embodiment of the present invention, a user can click on the button 418 when a meal order item from the horizontal section 452 has been selected. Subsequently, nutritional information regarding the selected meal order item is displayed in the area 454 or another graphical user interface is initiated and displays the nutritional information. The nutritional information can include the ingredients of the meal order item, the serving size, the calories, at least one activity for expending an amount of energy equal to the calories of the meal order item, the manner in which the meal order item relates to a dietary plan and a percentage of recommended daily allowances for a list of substances such as vitamins and minerals.

FIG. 4 further shows a button 420 for a jukebox or other audio/video output mechanism. The button 420 can launch another graphical user interface for interacting with a mechanism for outputting audio and/or video. The graphical user interface may control the play of a video or song on the display or speakers at the user's table, such as on the terminal 106. The graphical user interface may also control the play of a video or song on a public display or public speakers accessible by other consumers at the restaurant. Like a conventional jukebox, more than one consumer can choose a video or song for play (which may require payment) and the selections are played in the order in which they are received. Alternatively, a user can force the immediate or quicker play of his selection in exchange for a payment or a larger payment.

FIG. 4 further shows a button 422 for selecting and/or watching video. The button 422 can launch another graphical user interface for interacting with a mechanism for displaying video. The graphical user interface may control the play of a video on the display at the user's table, such as on the terminal 106. The graphical user interface may also control the play of a video on a public display accessible by other consumers at the restaurant. The consumer may select the video from a web cam selection provided via a web browser or from another video source. The consumer may select the video from a selection of television stations, DVDs, CDs, etc.

FIG. 4 further shows a button 424 for viewing or requesting a receipt or bill of the meals ordered. Button 424 may initiate a separate graphical user interface for viewing the bill or receipt and permitting the customers at one table to divide the receipt or sum the receipt. Button 426 provides user help in the event the consumer is not able to understand or operate any part of the interface 400.

FIG. 4 further shows a button 428 for selecting a filter or viewing preference for viewing the meal order items by meal, i.e., by combinations of meal order items. Many food establishments offer daily specials consisting of a combination of an appetizer, a salad, an entree, a desert, etc. Pressing the button 428 initiates a graphical user interface that allows a user to view meal order items by meal, i.e., by different combinations of meal order items. The combinations may be created to adhere to certain dietary plans, such as a low carbohydrate diet, a low calorie diet, a gourmet diet, a vegetarian diet, etc. The graphical user interface may simply allow a user to view all meal combinations including the diet to which each one adheres. The graphical user interface may also allow a user to select a particular type of diet and view all meal combinations that adhere to that diet.

FIG. 4 further shows a button 430 for selecting a filter or viewing preference for viewing the meal order items by type. Pressing the button 430 initiates a graphical user interface that allows a user to view meal order items by type, e.g., organized by desert dishes, appetizer dishes, meat dishes, poultry dishes, etc. The meal order items may be organized by any designation. The graphical user interface may simply allow a user to view all meal order items including the type associated with each item. The graphical user interface may also allow a user to select a particular type of meal order item and view all meal order items that belong to that type.

FIG. 4 further shows a button 432 for selecting a filter or viewing preference for viewing the meal order items by diet. Many food establishments offer daily specials consisting of a combination of an appetizer, a salad, an entree, a desert, etc. Pressing the button 432 initiates a graphical user interface that allows a user to view meal order items by meal, i.e., by different combinations of meal order items. The combinations may be created to adhere to certain dietary plans, such as a low carbohydrate diet, a low calorie diet, a vegetarian diet, a gourmet diet, etc. The graphical user interface may simply allow a user to view all meal combinations including the diet to which each one adheres. The graphical user interface may also allow a user to select a particular type of diet and view all meal combinations that adhere to that diet.

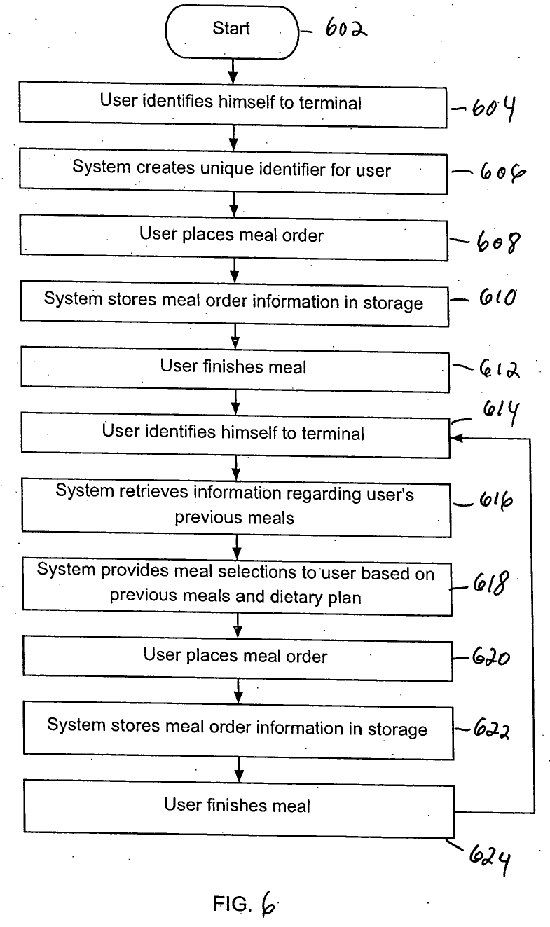

Button 432 may also be used to effectuate a balanced meal system wherein a user is provided with selectable meal order items based on previous meals, in order to adhere to a balanced meal dietary plan. A balanced meal dietary plan is an eating plan that involves the balanced intake of various types of foods, so as to insure that an individual meets recommended daily allowances of certain foods, vitamins and minerals. The present invention allows a user to store his meal orders so that the system can suggest meals based on his previous meal orders, so as to adhere to a balanced meal diet. The manner in which the system of the present invention saves meal order information and subsequently retrieves it in order to suggest meal orders is described in greater detail below with reference to FIG. 6.

FIG. 4 further shows a button 434 for viewing auction information regarding meal order items. In an embodiment of the present invention, meal order items can be placed on auction upon their preparation. Meal order items may be placed on a standard auction wherein multiple users place their bids and the meal order item is sold to the highest bidder. Other types of auctions include a silent auction and a Dutch auction. Upon pressing button 434, a graphical user interface is initiated for viewing auction information and allowing the consumer to place bids.

Alternatively, the price of prepared meal order items can be time based, such that the price of the meal order item decreases over time as the expiration of a prepared item draws near. The price of prepared meal order items can also be based on certain hours of the day, such that the price of the meal order item changes during peak hours or during slow hours. The price of prepared meal order items can also be based on certain times of the month, times of the week and times of the year, such that the price of the meal order item changes during peak times or during slow times. In another alternative, the price of a meal order item can be lowered if a customer vacates his table early, if the customer orders a meal order item that is prepared quickly resulting in the table being vacated earlier, or if the customer selects his meal for take out.

FIG. 4 further includes a button 436 for viewing information regarding drinks or beverages, such as images of the beverages, pricing information and nutritional information. Pressing button 436 initiates a graphical user interface for viewing the beverage information. Also included is a button 438 for viewing information regarding merchandise that is sold by the food establishment, such as clothing, memorabilia or other merchandise. Pressing button 438 initiates a graphical user interface for viewing the merchandise information.

FIG. 4 shows a button 440 for deactivating or clearing all filters or other organizational arrangements that were effectuated by the buttons 428, 430 and 432. Upon pressing button 440, meal order items are no longer viewed or arranged by predefined categories and are displayed either in no particular order or in a standard order, such as by alphabetical order. FIG. 4 further shows a horizontal section 450 including a variety of selectable buttons, each representing a separate user. Separate customers at one table may associate their identity with one color and a name. Subsequently, customers may indicate individual preferences for diets and foods. When meal order items are displayed, colors associated with customers are displayed so as to indicate that the meal order item is associated with a customer's dietary profile.

FIG. 5 is a screenshot of the graphical user interface of FIG. 4, according to one embodiment of the present invention. FIG. 5 shows an exemplary embodiment of the graphical user interface 400 of FIG. 4.

The interface 400 shows the horizontal section 452 that includes a series of rectangular areas or tiles on which images of meal order items are displayed. The horizontal section 452 is a sliding, rotating or scrolling bar or wheel that can be moved by using controls 412 or 410 on either side of the horizontal section 452. As rectangular areas or tiles are scrolled out to the right, new tiles appear to the left and, conversely, as rectangular areas or tiles are scrolled out to the left, new tiles appear to the right. The controls 412 or 410 include buttons for scrolling in either the right or left direction, as well as a button for stopping or pausing the rotation or scrolling of the horizontal section 452.

FIG. 6 is a flowchart showing the control flow of the meal order process of one embodiment of the present invention. FIG. 6 shows the process by which a user orders a meal using the terminal 202 and by which the system of the present invention stores a user's meal order information for future use. The process of FIG. 6 can be used to effectuate a balanced meal diet for users, as described in greater detail above with reference to FIG. 4. The process of FIG. 6 can further be used to effectuate other types of dietary plans for users, based on their previous eating history.

The control flow of FIG. 6 begins with step 602 and flows directly to step 604. In step 604, a user identifies himself to the terminal 202. The user may perform this task by supplying a name, a handle, a number or any other identifying information.

In step 606, the system of the present invention creates a unique identifier for the user, such as a number. This unique identifier is utilized to index an account or file that corresponds to the user, such that the account or file may be accessed using the unique identifier. In step 608, the user places a meal order using the terminal 202. Then, the system stores the user's meal order in the user's account or file in step 610. The user finishes his meal and leaves the food establishment in step 612.

In step 614, the user visits the food establishment at a later data and identifies himself to the terminal 202 using his name, handle, number or any other identifying information. In step 616, the system of the present invention uses the unique identifier of the user to retrieve the account or file that corresponds to the user. Note that the user's account or file includes meal orders of the user from previous visits. In step 618, the system of the present invention provides a list of meal order items for selection to the user, based on the user's previous meals and dietary preferences. The system of the present invention seeks to provide the user with a particular type of diet, such as a balanced diet, a low carbohydrate diet or a low calorie diet. Thus, taking a balanced diet as an example, the present invention bases its current list of meal order items on the user's last meal or meals. For example, if the user's last meal was a vegetable entree, the present invention may suggest a list of meat entrees to the user.

In step 620, presented with a list of meal order items for selection, the user places another meal order using the terminal 202. Then the system stores the user's meal order in the user's account or file in step 622. The user finishes his meal and leaves the food establishment in step 624. Subsequently, the process of steps 614-624 are continually repeated as the user continues to visit the food establishment.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 7 is a high level block diagram showing an information processing system useful for implementing one embodiment of the present invention. The computer system includes one or more processors, such as processor 704. The processor 704 is connected to a communication infrastructure 702 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 708 that forwards graphics, text, and other data from the communication infrastructure 702 (or from a frame buffer not shown) for display on the display unit 710. The computer system also includes a main memory 706, preferably random access memory (RAM), and may also include a secondary memory 712. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art. Removable storage unit 718, represents a floppy disk, a compact disc, magnetic tape, optical disk, etc. which is read by and written to by removable storage drive 716. As will be appreciated, the removable storage unit 718 includes a computer readable medium having stored therein computer software and/or data.

In alternative embodiments, the secondary memory 712 may include other similar means for allowing computer programs or other instructions to be loaded into the computer system. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system.

The computer system may also include a communications interface 724. Communications interface 724 allows software and data to be transferred between the computer system and external devices. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. These signals are provided to communications interface 724 via a communications path (i.e., channel) 726. This channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 706 and secondary memory 712, removable storage drive 716, a hard disk installed in hard disk drive 714, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 706 and/or secondary memory 712. Computer programs may also be received via communications interface 724. Such computer programs, when executed, enable the computer system to perform the features of the present invention as discussed herein. In particular, the computer programs, when executed, enable the processor 704 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method for placing a meal order on an information processing system located within a food establishment, the method comprising:
providing to a customer a plurality of selectable meal order items on an interface;
receiving from the interface a selection of at least one meal order item selected by the customer; and
placing an order for the at least one meal order item selected by the customer.

2. The method of claim 1, the method further comprising:
providing to the customer on the interface a dynamic value for each meal order item, the dynamic value indicating a current quantity of the meal order item that is immediately available for delivery to the customer.

3. The method of claim 1, the method further comprising:
providing to the customer on the interface at least one of the following elements for each meal order item:
an image of the meal order item;
nutritional information associated with the meal order item;
a relationship between the meal order item and at least one dietary plan; and
at least one activity for expending an amount of energy equal to the calories associated with the meal order item.

4. The method of claim 1, the method further comprising:
providing to the customer on the interface at least one filter for organizing the plurality of meal order items, wherein the at least one filter organizes the plurality of meal order items by at least one of meal order item type, meal order item combinations and meal order item nutritional information.

5. The method of claim 1, the method further comprising:
generating a unique identifier associated with the customer;
storing the at least one meal order item selected by the customer; and
associating the unique identifier with the at least one meal order item that was stored.

6. The method of claim 5, the method further comprising:
associating a customer with a unique identifier previously associated with the customer;
retrieving meal order item information previously stored in association with the unique identifier; and
providing to the customer a set of selectable meal order items on the interface, the set of meal order items based on the meal order item information previously stored and on a dietary plan.

7. The method of claim 6, the method further comprising:
receiving from the interface a selection of at least one meal order item selected by the customer;
placing an order for the at least one meal order item selected by the customer;
storing the at least one meal order item selected by the customer; and
associating the unique identifier with the at least one meal order item that was stored.

8. An information processing system located within a food establishment for placing a meal order, comprising:
a display for providing to a customer a plurality of selectable meal order items;
an interface for receiving a selection of at least one meal order item selected by the customer; and
a processor configured to place an order for the at least one meal order item selected by the customer.

9. The information processing system of claim 8, wherein the display further provides to the customer a dynamic value for each meal order item, the dynamic value indicating a current quantity of the meal order item that is immediately available for delivery to the customer.

10. The information processing system of claim 8, wherein the display further provides to the customer at least one of the following elements for each meal order item:
an image of the meal order item;
nutritional information associated with the meal order item;
a relationship between the meal order item and at least one dietary plan; and
at least one activity for expending an amount of energy equal to the calories associated with the meal order item.

11. The information processing system of claim 8, wherein the display further provides to the customer at least one filter for organizing the plurality of meal order items, wherein the at least one filter organizes the plurality of meal order items by at least one of meal order item type, meal order item combinations and meal order item nutritional information.

12. The information processing system of claim 11, wherein the interface further allows the customer to associate a color with each customer, so as to associate meal order items with colors associated with customers.

13. The information processing system of claim 8, further comprising:
memory for storing a unique identifier for each customer and the at least one meal order item selected by the customer.

14. The information processing system of claim 13, wherein the memory comprises a random-access memory.

15. The information processing system of claim 8, wherein the processor comprises an application specific integrated circuit.

16. A computer readable medium including computer instructions for placing a meal order on an information processing system located within a food establishment, the computer instructions including instructions for:
providing to a customer a plurality of selectable meal order items on an interface;
receiving from the interface a selection of at least one meal order item selected by the customer; and
placing an order for the at least one meal order item selected by the customer.

17. The computer readable medium of claim 16, further comprising instructions for:
providing to the customer on the interface a dynamic value for each meal order item, the dynamic value indicating a current quantity of the meal order item that is immediately available for delivery to the customer.

18. The computer readable medium of claim 16, further comprising instructions for:
providing to the customer on the interface at least one of the following elements for each meal order item:
an image of the meal order item;
nutritional information associated with the meal order item;
a relationship between the meal order item and at least one dietary plan; and
at least one activity for expending an amount of energy equal to the calories associated with the meal order item.

19. The computer readable medium of claim 16, further comprising instructions for:
providing to the customer on the interface at least one filter for organizing the plurality of meal order items, wherein the at least one filter organizes the plurality of meal order items by at least one of meal order item type, meal order item combinations and meal order item nutritional information.

20. The computer readable medium of claim 16, further comprising instructions for:
generating a unique identifier associated with the customer;
storing the at least one meal order item selected by the customer; and
associating the unique identifier with the at least one meal order item that was stored.
